(19) United States
(12) Patent Application Publication
(10) Pub. No.: US 2016/0003346 A1
(43) Pub. Date: Jan. 7, 2016

(54) DRIVE CONTROL METHOD AND SYSTEM FOR ELECTRIC OIL PUMP

(71) Applicant: Hyundai Motor Company, Seoul (KR)

(72) Inventors: Hak Sung LEE, Gunpo-Si (KR); June Ho LEE, Seoul (KR); Young Chul KIM, Gwangmyeong-Si (KR)

(73) Assignee: Hyundai Motor Company, Seoul (KR)

(21) Appl. No.: 14/550,961

(22) Filed: Nov. 22, 2014

(30) Foreign Application Priority Data
Jul. 4, 2014 (KR) 10-2014-0083940

(51) Int. Cl. F16H 57/04

(52) U.S. Cl. CPC F16H 57/0447

(57) ABSTRACT

A drive control system for an electric oil pump may include the electric oil pump supplying operating hydraulic pressure to a transmission, a data detector detecting data, and a controller setting an operation mode of the electric oil pump on the basis of data detected by the data detector, setting a basic oil amount on the basis of oil amounts for a high-pressure part and a low-pressure part according to the set operation mode, and applying operating hydraulic pressure to the electric oil pump on the basis of a final oil amount by compensating the basic oil amount, wherein the operating hydraulic pressure may be supplied to the transmission by the electric oil pump.

### CROSS-REFERENCE TO RELATED APPLICATION

The present application claims priority of Korean Patent Application Number 10-2014-0083940 filed on Jul. 4, 2014, the entire contents of which application are incorporated herein for all purposes by this reference.

### BACKGROUND OF THE INVENTION

1. Field of the Invention

The present invention relates, in general, to a drive control method and system for an electric oil pump, and, more particularly, to a drive control method and system for an electric oil pump which can improve the efficiency of a transmission and fuel efficiency of hybrid electric vehicles by providing pumps for separately supplying oil to a high-pressure part and a low-pressure part divided in accordance with running states of a vehicle, in an EOP system driven independently.

2. Description of Related Art

In general, hybrid electric vehicles refer to vehicles that are equipped with a power source composed of an engine and a driving motor driven by power supplied by a battery and can improve fuel efficiency by appropriately applying the power source to the front wheels, using the power of the motor driven by voltage of the battery, as auxiliary power, when they are started or accelerated.

Hybrid electric vehicles with an automatic transmission need to prepare for the stop of the engine while they are running, such as stop-and-go, and to this end, other than an existing mechanical oil pump, an electric oil pump for supplying oil to the automatic transmission is additionally mounted in parallel with the mechanical oil pump.

However, recently, a system that supplies oil to an automatic transmission, using only an electric oil pump (EOP), without a mechanical oil pump (MOP) to increase efficiency of a transmission and improve fuel efficiency of a vehicle has been developed and used and the present invention also relates to drive control method and system for an electric oil pump that is mounted on a hybrid electric vehicle with only an electric oil pump (EOP).

FIG. 1 is a schematic diagram of a system for supplying oil to an automatic transmission in hybrid electric vehicles in the related art, showing the path of ATF (Auto Transmission Fluid) used for a transmission and a clutch and a path for supplying oil in an oil tank 51 to a valve body 53 through a hydraulic line 52 by operating an electric oil pump 71 and a mechanical oil pump 75.

For reference, in general, hydraulic pressure is supplied to the hydraulic line 52 by the electric oil pump 71 in an EV mode, while hydraulic pressure is supplied to the hydraulic line 52 by both of the mechanical oil pump 75 and the electric oil pump 71 in an HEV mode (engine operated and engine clutch connected).

FIG. 2 is a schematic view showing supply of oil to a high-pressure part and a low-pressure part with one pump in an EOP system driven independently that is under development. As shown in the figure, it is possible to find that oil is pumped out to the low-pressure part and the high-pressure part by one pump, when oil is supplied to a valve body with an EOP driven independently.

Accordingly, it is required to make a study of optimizing the operation of an EOP, increasing efficiency of a transmission, and improving fuel efficiency of a vehicle, when an EOP is independently driven, and particularly, it has been studied to minimize power by providing two pumps independently for a low-pressure part and a high-pressure part and supplying optimum hydraulic pressure and oil amount.

Therefore, various aspects of the present invention are directed to providing a drive control method and system for an electric oil pump which improve efficiency of a transmission by supplying oil to a high-pressure part and a low-pressure part with two pumps in an EOP system driven independently.

In the related art, “Method of controlling an electric oil pump of a hydraulic car” and “Hydraulic control system for vehicle automatic transmission” have been proposed, respectively.

As for the “Method of controlling an electric oil pump of a hydraulic car”, an electric oil pump is operated, when hydraulic pressure from an automatic transmission is or is likely to be lower than required hydraulic pressure, such that power consumption by the electric oil pump can be optimized and fuel efficiency can be improved; however, there is no description about the spirit of the present invention which controls oil supply with two oil pumps for a high-pressure part and a low-pressure part, respectively, and the effect is considerably lower than that of the present invention. Further, as for the “Hydraulic control system for vehicle automatic transmission”, it is similar to the present invention in that the necessary amount of oil is determined and a motor is controlled on the basis of the amount; however, there is also no description about the spirit of the present invention which controls oil supply with two oil pumps for a high-pressure part and a low-pressure part, respectively, and the concerned problems in the related art are different from those of the present invention.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a drive control method and system for an electric oil pump which increase efficiency of the transmission and fuel efficiency of a vehicle, using two pumps that can separately supply oil to a high-pressure part and a low pressure part, by improving a system for simultaneously supplying oil to a high-pressure part and a low-pressure part with one pump from an EOP system driven independently, which is under development, in order to optimally supply oil in accordance with running states of a vehicle via an EOP system driven independently for hybrid electric vehicles.

The present invention also relates to a drive control system for an electric oil pump.

In an aspect of the present invention, there is provided a drive control system for an electric oil pump, which includes: an electric oil pump supplying operating hydraulic pressure to a transmission; a data detector detecting data; and a controller setting an operation mode of the electric oil pump on the basis of data detected by the data detector, setting a basic oil amount on the basis of oil amounts for a high-pressure part and a low-pressure part according to the set operation mode, and applying operating hydraulic pressure to the electric oil pump on the basis of a final oil amount by compensating the basic oil amount, in which the operating hydraulic pressure is supplied to the transmission only by the electric oil pump.

An oil amount for the high-pressure part according to a set operation mode and an oil amount for the low-pressure part according to a set operation mode may supply operating hydraulic pressure to the transmission by means of a first pump and a second pump, respectively.

The electric oil pump may supply operating hydraulic pressure to the transmission in accordance with a speed instruction and the speed instruction may be calculated on the basis of desired hydraulic pressure, oil temperature, and the final oil amount.

The operation mode may include a first control mode set for a stopping condition and a second control mode set for a running condition.

The operation mode may further include a third control mode set for a starting-condition, and the third control mode may be maintained for a predetermined time.

The controller may calculate the oil amount for the high-pressure part and the oil amount for the low-pressure part from a basic oil amount map about a relationship between oil temperature and desired hydraulic pressure stored in accordance with a set operation mode.

The controller may compare the oil amount for the high-pressure part and the oil amount for the low-pressure part with each other and then set the larger one as the basic oil amount, and calculate the final oil amount by adding a compensation oil amount for leakage to the basic oil amount.

The controller may calculate the oil amount for the low-pressure part for each operation mode on the basis of oil amount for cooling and lubricating the transmission.

The oil amount for the high-pressure part in the first control mode may produce minimum hydraulic pressure, when a vehicle stops, the oil amount for the high-pressure part in the second control mode may produce hydraulic pressure allowing for torque transmission, when a vehicle is running, and the oil amount for the high-pressure part in the third control mode may be set to ensure hydraulic response of the transmission.

The electric oil pump may keep operating from when an engine of a vehicle is started to when the engine is stopped.

Further, the present invention relates to a drive control system for an electric oil pump implemented in the system described above.

According to another aspect of the present invention, there is provided a drive control method for an electric oil pump, which includes: setting an operation mode of an electric oil pump on the basis of data detected by a data detector; calculating a basic oil amount on the basis of oil amounts for a high-pressure part and a low-pressure part according to the set operation mode; calculating a final oil amount by compensating the basic oil amount; calculating a speed instruction of the electric oil pump on the basis of the final oil amount; and controlling operation of the electric oil pump in accordance with the calculated speed instruction.

The oil amount for the high-pressure part and the oil amount for the low-pressure part may supply operating hydraulic pressure to a transmission by means of separate pumps.

The electric oil pump may supply operating hydraulic pressure to the transmission in accordance with a speed instruction and the speed instruction may be calculated on the basis of desired hydraulic pressure, oil temperature, and the final oil amount.

The operation mode may include a first control mode set for a stopping condition and a second control mode set for a running condition.

The operation mode may further include a third control mode set for a starting-condition, and the third control mode may be maintained for a predetermined time.

The calculating a basic oil amount on the basis of oil amounts for a high-pressure part and a low-pressure part in a se operation mode may calculate the oil amount for the high-pressure part and the oil amount for the low-pressure part from a basic oil amount map about a relationship between oil temperature and desired hydraulic pressure stored in a set operation mode.

The oil amount for the high-pressure part and the oil amount for the low-pressure part are compared and then the larger one may be set as the basic oil amount, and the final oil amount may be calculated by adding a compensation oil amount for leakage to the basic oil amount.

The oil amount for the low-pressure part may be set for each operation mode on the basis of oil amount for cooling and lubricating the transmission.

The oil amount for the high-pressure part in the first control mode may produce minimum hydraulic pressure, when a vehicle stops, the oil amount for the high-pressure part in the second control mode may produce hydraulic pressure allowing for torque transmission, when a vehicle is running, and the oil amount for the high-pressure part in the third control mode may be set to ensure hydraulic response of the transmission.

According to the drive control method and system for an electric oil pump, the following various effects are achieved.

First, it is possible to increase efficiency of a transmission by optimizing operation of an oil pump for the transmission.

Second, it is possible to increase fuel efficiency of a vehicle by increasing efficiency of a transmission.

Third, since separate pumps for supplying oil to a high-pressure part and a second pressure part are provided in an EOP system driven independently, oil can be effectively supplied, in accordance with running conditions of a vehicle.

Fourth, since the first pump for supplying oil to the high-pressure part and the second pump for supplying oil to the low-pressure part are arranged on the same shaft, they can be mounted in an existing space and the package is optimized.

Fifth, since a three-dimensional map about desired hydraulic pressure, oil temperature, a final oil amount, and a speed instruction of the electric oil pump is used, it is possible to accurately and stably supply a necessary amount of operating hydraulic pressure to a transmission.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram showing a configuration for supplying oil to an automatic transmission in a hybrid electric vehicle of the related art.

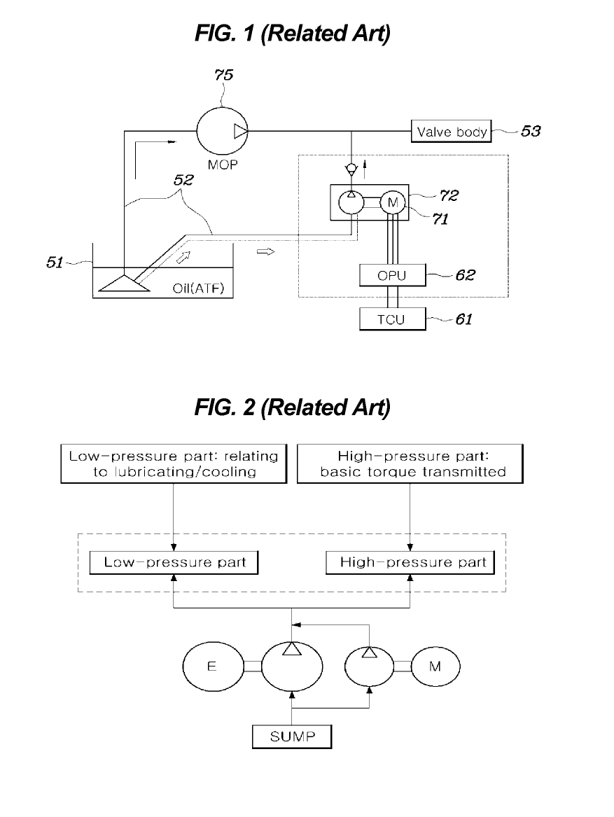

FIG. 2 is a schematic diagram showing a configuration for supplying oil to a high-pressure part and a low-pressure part with one pump in the related art.

FIG. 3 is a diagram showing the entire configuration of a drive control system for an electric oil pump of the present invention.

FIG. 4 is a flowchart illustrating a drive control method of an electric oil pump of the present invention.

FIG. 5 is a schematic diagram illustrating the drive control method of an electric oil pump of the present invention.

FIG. 6 and FIG. 7 are diagrams showing operation modes of an electric oil pump according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinbelow, preferred embodiments of drive control method and system for an electric oil pump of the present invention will be described with reference to the accompanying drawings.

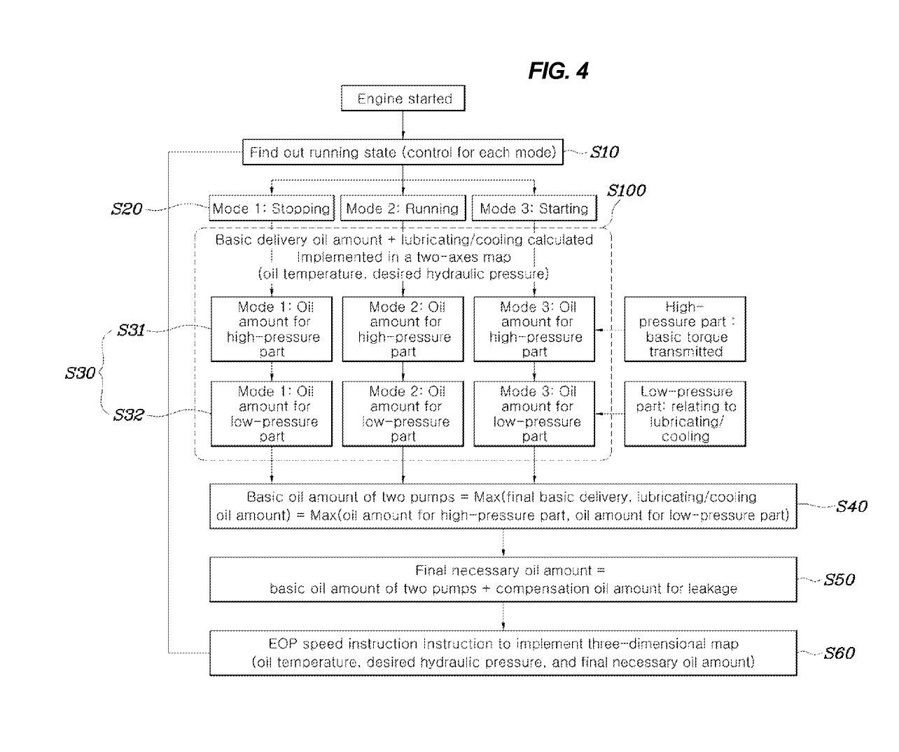

FIG. 3 is a diagram showing the entire configuration of a drive control system for an electric oil pump according to an exemplary embodiment of the present invention and the system includes largely an electric oil pump 10, a data detector 400, and a controller 300.

It is different from an EOP system driven independently, which is under development, in that pumps supplying oil to a high-pressure part and a low-pressure part are separately provided.

That is, though described in detail below, a first pump 100 is provided for the high-pressure part that produces minimum hydraulic pressure, when a vehicle is stopped and a second pump 200 is provided for the low-pressure part associated with lubricating and cooling, such that optimum hydraulic pressure and oil amount are provided, thereby minimizing a loss of power.

The control process of the present invention can be performed, as in the normal case, by a transmission control unit (TCU) and an electric oil pump unit (OPU), in which the transmission control unit calculates the optimum oil supply in accordance with running states of a vehicle and then sends a corresponding signal to the oil pump controller and the oil pump controller supplies the calculated optimum amount of oil by controlling the number of revolutions of a pump in accordance with the running states.

As well known in the art, a transmission is a device for shifting by changing the gear ratios from the input shaft to the output end. Further, transmissions perform shifting by operating a plurality of friction elements including at least one or more brakes and at least one or more clutches. Those friction elements are coupled or uncoupled by operating hydraulic pressure supplied to the transmissions.

An electric oil pump supplies operating hydraulic pressure to an engine clutch and a transmission by pumping up oil and keeps operating from when the engine of a hybrid electric vehicle is started to when it is stopped. That is, a mechanical oil pump is not provided and an electric oil pump constantly operates.

As shown in FIG. 3, the data detector 400 detects data for controlling the electric oil pump 10 and the data detected by the data detector 400 is sent to the controller 300.

The controller 300 sets an operation mode on the basis of the data detected by the data detector 400 and oil is optimally supplied to a transmission in accordance with the operation mode by the first pump 100 and the second pump 200.

The data detector 400 may include an acceleration pedal position sensor 410, a brake pedal position sensor 420, a vehicle speed sensor 430, a shift gear sensor 410, and an oil temperature sensor 450.

The acceleration pedal position sensor 410 senses the information about an acceleration pedal pressed down by a driver. That is, the acceleration pedal position sensor 410 measures data about the intention of accelerating by a driver.

The brake pedal position sensor 420 detects whether a brake pedal is pressed down or not. That is, the brake pedal position sensor 420 detects the intention of accelerating by a driver in cooperation with the acceleration pedal position sensor 410.

The vehicle speed sensor 430 is mounted on a vehicle and measures the speed of the vehicle. In rare instances, it may be possible to calculate a vehicle speed on the basis of a GPS signal from a GPS (Global Positioning System).

On the other hand, on the basis of a signal from the acceleration pedal position sensor 410 and a signal from the vehicle speed sensor 430, it is possible to calculate a desired shift gear, using a shift pattern, and shifting to the desired shift gear is controlled. That is, in an automatic transmission with a plurality of planetary gear sets and a plurality of friction elements, hydraulic pressure supplied to the friction elements or removed from the friction elements is controlled. Further, in a double clutch transmission, a current supplied to a plurality of synchronizers and an actuator is controlled.

The shift gear sensor 440 detects the currently engaged shift gear. The oil temperature sensor 450 detects the temperature of transmission oil.

The controller 300 may include a transmission control unit (TCU) and an electric oil pump unit (OPU). The drive control system for an electric oil pump according to an exemplary embodiment of the present invention may be achieved by the transmission control unit and the electric oil pump unit.

The transmission control unit is a device for controlling torque of a transmission and operation of a plurality of friction elements. The transmission control unit can set operation modes for the first pump 100 and the second pump 200 of the electric oil pump 10 on the basis of the data detected by the data detector 400 and calculate and transmit speed instructions to the electric oil pump unit in accordance with the set operation modes.

To this end, the transmission control unit may be achieved by one or more processors operating in accordance with predetermined programs and the programs may be written to perform the steps of a drive control system for an electric oil pump according to an exemplary embodiment of the present invention.

The electric oil pump unit is connected with the electric oil pump 10 and controls the operation of the electric oil pump 10 in accordance with the speed instructions.

Some processes of a drive control system for an electric oil pump according to an exemplary embodiment of the present invention to be described below may be performed by the transmission control unit and the other processes may be performed by the electric oil pump unit.

Accordingly, the drive control system for an electric oil pump according to an exemplary embodiment of the present invention can be described with a transmission control unit and an electric oil pump unit as one controller 300, so the transmission control unit and the electric oil pump unit are called a controller 300 herein.

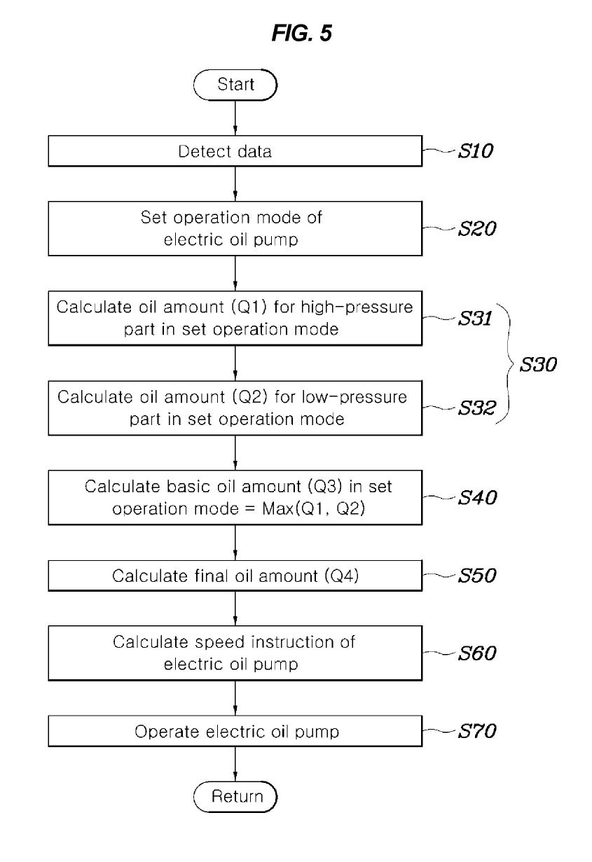

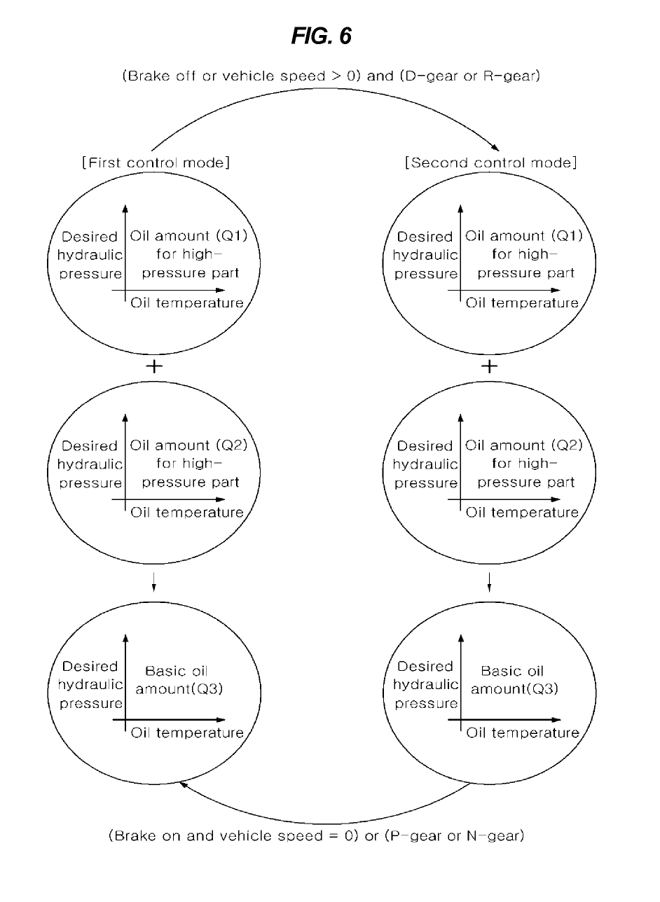

FIG. 4 is a flowchart illustrating a drive control method for an electric oil pump according to an exemplary embodiment of the present invention and FIG. 5 is a flowchart schematically illustrating the method.

As shown in FIGS. 4 and 5, a drive control method for an electric oil pump of the present invention finds out running states to control a vehicle in each mode by detecting data (S10).

The operation modes of the electric oil pump 10 are set on the basis of the data, the optimum oil supply is divided for operation modes according to the vehicle states, that is, a start mode (Mode 1), a stop mode (Mode 2), and a running mode (Mode 3) in the process of controlling the oil pump according to an exemplary embodiment of the present invention, and oil is optimally supplied for each of the running states, using MAP data to be described in detail below, in the modes.

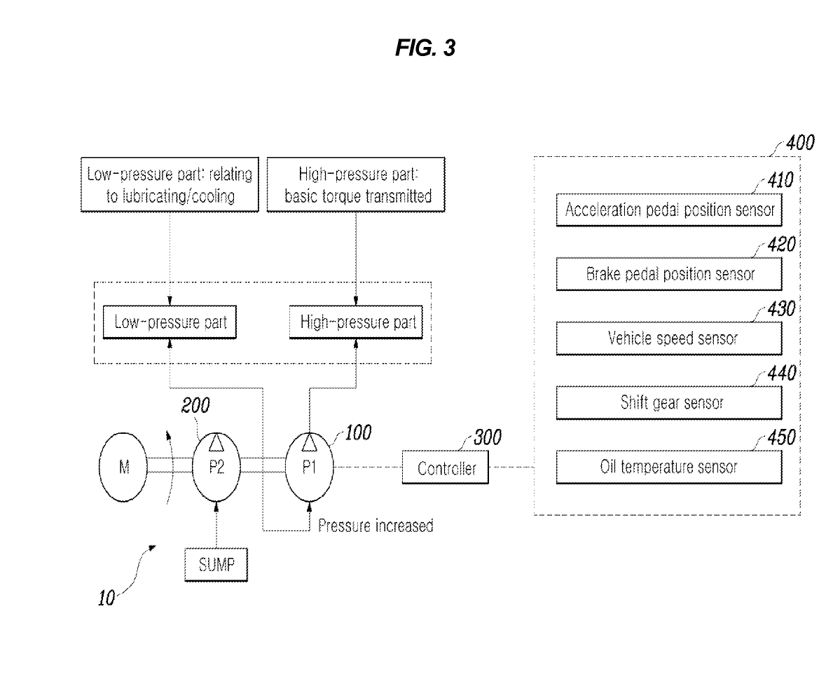

According to an exemplary embodiment of the present invention, it is possible to increase efficiency of a transmission and fuel efficiency of a vehicle by optimally supplying oil for each of modes according to the running states of a vehicle, in an EOP system driven independently, but as shown in FIG. 2, oil is supplied to both of a high-pressure part and a low-pressure part by one pump, such that there is still a problem to be improved in order to increase the fuel efficiency.

Accordingly, the present invention provides another drive control method for an electric oil pump which can increase efficiency of a transmission and fuel efficiency by separately supplying oil to a high-pressure part and a low-pressure part, using two pumps.

That is, as shown in FIG. 3, operating hydraulic pressure is supplied to a transmission by supplying oil, using the first pump 100 for the high-pressure part and the second pump 200 for the low-pressure part, in accordance with operation modes.

The oil amount Q1 for the high-pressure part and the oil amount Q2 for the low-pressure part are supplied to the transmission by the first pump 100 and the second pump 200, respectively, in the predetermined operation modes.

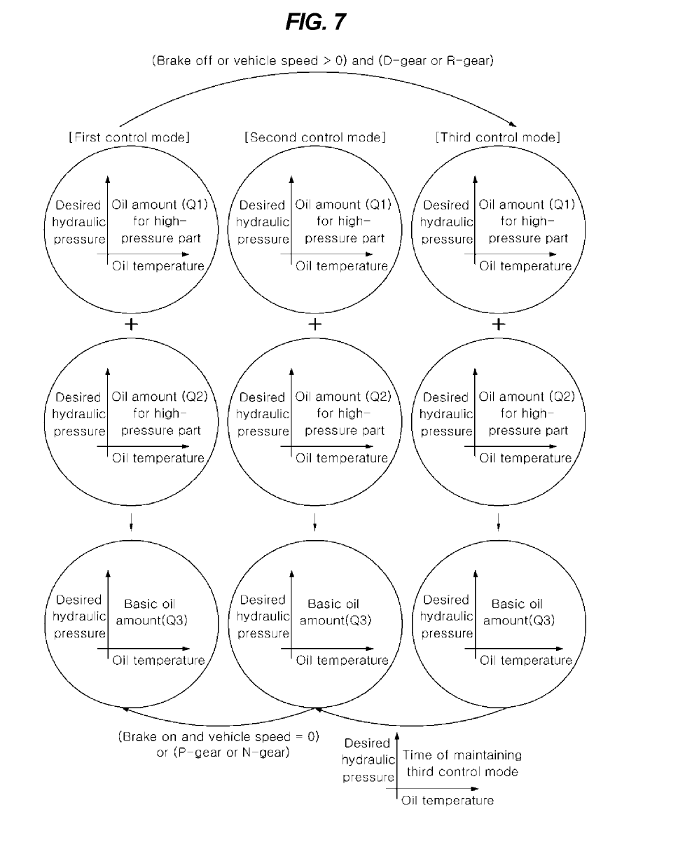

Referring to FIGS. 4 and 6 again, the operation modes include a first control mode (Mode 1) and a second control mode (Mode 2).

The first control mode is a mode for operating the electric oil pump 10 with a hybrid electric vehicle stopped. In the first control mode, the oil amount Q1 for the high-pressure part is the minimum oil amount for minimizing power consumption and the oil amount Q2 for the low-pressure part is the oil amount based on the oil amount for cooling and lubricating the transmission.

In an exemplary embodiment of the present invention, the oil amount Q1 for the high-pressure part and the oil amount Q2 for the low-pressure part are calculated and then the larger one is set as a basic oil amount Q3 for the control modes.

The first control mode is a mode for operating the electric oil pump 10 with a hybrid electric vehicle stopped. The oil amount Q1 for the high-pressure part supplies minimum hydraulic pressure for minimizing power consumption in the first control mode, the controller 300 operates the electric oil pump 10 under the first control mode, and for example, as shown in FIG. 6, the stopping condition may be assumed as being satisfied, when the brake is in an On-state and the vehicle speed is zero or when a parking gear (P-gear) or a neutral gear (N-gear) is engaged.

The second control mode is a mode for operating the electric oil pump 10 with a hybrid electric vehicle running.

Obviously, in the second control mode too, the oil amount Q1 for the high-pressure part and the oil amount Q2 for the low-pressure part are calculated and then the larger one is set as basic oil amount Q3 for the second control mode.

Similarly, the oil amount Q2 for the low-pressure part is calculated on the basis of the oil amount for cooling and lubricating the transmission.

The controller 300 operates the electric oil pump 10 under the second control mode, when the engine is started or the vehicle is running, and for example, the running condition may be assumed as being satisfied, when the brake is in an Off-state, or when the vehicle speed is larger than zero and the drive gear (D-gear) or the reverse gear (R-gear) is engaged.

As shown in FIG. 7, the operation modes may further include a third control mode (Mode 3).

Similarly, in the third control mode, the oil amount Q1 for the high-pressure part and the oil amount Q2 for the low-pressure part are calculated and then the larger one is set as basic oil amount Q3.

The third control mode is a mode for operating the electric oil pump 10 at a high speed with a hybrid electric vehicle started. In the third control mode, hydraulic response is ensured by the oil amount Q1 for the high-pressure part instantaneously supplying hydraulic pressure to the transmission for a predetermined time and the oil amount Q2 for the low-pressure part is calculated on the basis of the oil amount for cooling and lubricating the transmission.

That is, when the first control mode is changed directly to the second control mode, it is possible to quickly obtain standard pressure by instantaneously pumping oil at high pressure for a short time in consideration of when the revolution speed of the electric oil pump 10 cannot follow the speed instruction calculated in the second control mode (for example, the battery voltage is low).

The controller 300 can operate the electric oil pump 10 in the third control mode, when the engine is started or the vehicle is started. The vehicle-starting condition may be assumed as being satisfied, when the brake is in an Off-state, or when the vehicle speed is larger than zero and the drive gear (D-gear) or the reverse gear (R-gear) is engaged.

The controller 300 can calculate a predetermined time set on the basis of a two-dimensional map about the relationship of the oil temperature, the desired hydraulic pressure, and the above predetermined time (the time of keeping the third control mode). When the predetermined time passes, the controller 300 changes the operation mode from the third control mode to the second control mode.

After setting the operation modes of the electric oil pump 10 in step S20, the controller 30 calculates the basic oil amount Q3 of the operation mode set from a basic oil amount map (S40), that is, as described above, the oil amount Q1 for the high-pressure part and the oil amount Q2 for the low-pressure part are compared and the larger one is selected as the basic oil amount Q3.

The basic oil amount map may be a two-dimensional map keeping the information about the basic oil amount for each of the operation modes and having the oil temperature and the desired hydraulic pressure as variables. That is, the controller 300 can calculate the basic oil amount Q3 in accordance with the current oil temperature and desired hydraulic pressure, using the information of the basic oil amount map.

The oil amount for the high-pressure part in the first mode produces the minimum hydraulic pressure, when the vehicle is stopped, in the two-dimensional map, the oil amount for the low-pressure part in the second mode produces hydraulic pressure allowing for transmission of torque, when the vehicle is running, in the two-dimensional map, and the oil amount for the high-pressure part in the third mode is set to ensure hydraulic response of the transmission, in the two-dimensional map.

The controller 300 can calculate the oil amount Q2 for the low-pressure part too on the basis of cooling and lubricating of the transmission (S32).

The controller 300 calculates a compensation oil amount for cooling and lubricating the transmission, using a compensation oil amount map, which may include a two-dimensional map keeping the information about the relationship of oil temperature, heat generation, and a compensation oil amount in consideration of the cooling and lubricating. Further, when the final oil amount Q4 is calculated after the basic oil amount Q3 is calculated, a compensation oil amount for leakage is added to the basic oil amount Q3 and the compensation oil amount for leakage may also include a two-dimensional map keeping the information about the relationship of oil temperature, valve control pressure, and a compensation oil amount.

However, the method of calculating a compensation oil amount, using a compensation oil amount map, is only an example and the present invention is not limited thereto.

For example, in lubricating, cooling, and calculating of a compensation oil amount for leakage, the controller 300 may consider heat generation X₁ in the driving motor system (motor or bearing etc.), heat generation X₂ in the transmission output system (differential gear or bearing etc.), heat generation X₃ in the bush system (shaft bust etc.), heat generation X₄ in the planetary gear system (planetary gear and needle roller bearing etc.), and heat generation X₅ in slipping of a plurality of friction elements (clutch and brake).

Further, the controller 300 may consider oil leakage from the transmission due to excessive control in shifting, when it calculates the compensation oil amount. That is, the controller 300 can calculate the compensation oil amount on the basis of oil leakage from a plurality of valves in the transmission. In the variables, symbols, and constants in various equations used herein, ones apparent to those skilled in the art are not described in detail for the convenience of description.

The heat generation X₁ in the driving motor system can be calculated from an equation, X₁=|w₁*(|T₁|*k₁₁+k₁₂)|, where is an absolute value function, w₁ is revolution speed of a driving motor, T₁ is torque of the driving motor, k₁₁ is a loss rate of the driving motor, and k₁₂ is a bearing drag constant of the driving motor. The loss rate of the driving motor is a value between 0 and 1 and it can be calculated from a two-dimensional map about the relationship of the revolution speed of the driving motor, the absolute value of the torque of the driving motor, and the loss rate of the driving motor.

The heat generation X₂ in the transmission output system can be calculated from an equation, X₂=No*(|T₂|*k₂₁+k₂₂), where No is the number of revolutions of the transmission output shaft, T₂ is output shaft torque of the transmission, K₂₁ is a loss rate coefficient of the output shaft, and K₂₂ is a bearing drag constant of the output shaft.

The heat generation X₃ in the bush system can be calculated from an equation, X₃=v₃*k₃, where v₃ is the relative speed of a bush on the input shaft of the transmission and k₃ is a bush drag. The bush drag ranges from 0 to 10 and can be obtained from a two-dimensional map about the relationship between the relative speed of the bush and the bush drag.

The heat generation X₄ in the planetary gear system can be calculated from an equation, X₄=w₄*(|T₄|*|k₄₁−k₄₂)|, where w₄ is the rotational speed of a pinion gear, T₄ is transmission torque of the pinion gear, k₄₁ is a loss rate constant of the pinion gear, and k₄₂ is a bearing drag constant of the planetary gear system. The loss rate constant k₄₁ of the pinion gear and the bearing drag constant k₄₂ can be defined for each of a plurality of planetary gear sets.

The heat generation X₅ in slip of one friction element can be calculated from an equation, X₅=v₅*(P₅−k₅₁)*k₅₂, where v₅ is the relative speed of the friction element, P₅ is control pressure of the friction element, k₅₁ is a kiss point pressure constant of the friction element, and k₅₂ is an area constant of the friction element. The heat generation in slip of each friction element can be obtained in the same way as the heat generation in slip of one friction element.

The controller 300 can determine the maximum of the compensation oil amounts calculated on the basis of the variables as a compensation oil amount.

Thereafter, the controller 300 calculates the final oil amount Q4 by adding a compensation oil amount for leakage, which is a compensation oil amount, to the basic oil amount Q3 (S50).

The controller 300 calculates a speed instruction of the electric oil pump 10 from a speed instruction map (S60). The speed instruction map may be a three-dimensional map keeping the information about the speed instruction of the electric oil pump, with desired hydraulic pressure, oil temperature, and the final oil amount as variables. That is, the controller 300 can calculate the speed instruction of the electric oil pump in accordance with the desired hydraulic pressure, the oil temperature, and the final oil amount, using the information in the speed instruction map.

The controller 300 controls operation of the electric oil pump 10 on the basis of the calculated speed instruction (S70). Separately describing the controller 300 into the transmission control unit (TCU) and the electric oil pump unit (OPU), the transmission control unit can calculate a speed instruction and transmit it to the electric oil pump unit and the electric oil pump unit can operate the electric oil pump in accordance with the speed instruction.

A drive control method of an electric oil pump implemented in the system described above includes setting an operation mode of the electric oil pump on the basis of data detected by the data detector 400, calculating a basic oil amount Q3 on the basis of oil amounts Q1 and Q2 for a high-pressure part and a low-pressure part according to the set operation mode, calculating the final oil amount Q4 by compensating the basic oil amount, calculating a speed instruction of the electric oil pump 10 on the basis of the final oil amount, and controlling operation of the electric oil pump 10 in accordance with the calculated speed instruction.

The detailed procedure was described already, so it is not described here.

According to the system described above, the present invention can use a high-voltage electric oil pump available for a hybrid system and can achieve optimization of a package by arranging two pumps, the first pump 100 and the second pump 200, on the same shaft such that they can be mounted in an existing space.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A drive control system for an electric oil pump, comprising:
the electric oil pump supplying operating hydraulic pressure to a transmission;
a data detector detecting data; and
a controller setting an operation mode of the electric oil pump on the basis of data detected by the data detector, setting a basic oil amount on the basis of oil amounts for a high-pressure part and a low-pressure part according to the set operation mode, and applying operating hydraulic pressure to the electric oil pump on the basis of a final oil amount by compensating the basic oil amount,
wherein the operating hydraulic pressure is supplied to the transmission by the electric oil pump.

2. The system of claim 1, wherein an oil amount for the high-pressure part according to a set operation mode and an oil amount for the low-pressure part according to a set operation mode supply operating hydraulic pressure to the transmission by a first pump and a second pump, respectively.

3. The system of claim 2, wherein the electric oil pump supplies operating hydraulic pressure to the transmission in accordance with a speed instruction and the speed instruction is determined on the basis of desired hydraulic pressure, oil temperature, and the final oil amount.

4. The system of claim 2, wherein the operation mode includes a first control mode set for a stopping condition and a second control mode set for a running condition.

5. The system of claim 4, wherein the operation mode further includes a third control mode set for a starting-condition, and
the third control mode is maintained for a predetermined time.

6. The system of claim 4, wherein the controller determines the oil amount for the high-pressure part and the oil amount for the low-pressure part from a basic oil amount map about a relationship between oil temperature and desired hydraulic pressure stored in accordance with a set operation mode.

7. The system of claim 4, wherein the controller compares the oil amount for the high-pressure part and the oil amount for the low-pressure part with each other and then sets a larger one as the basic oil amount, and determines the final oil amount by adding a compensation oil amount for leakage to the basic oil amount.

8. The system of claim 4, wherein the controller determines the oil amount for the low-pressure part for each operation mode on the basis of oil amount for cooling and lubricating the transmission.

9. The system of claim 5, wherein the oil amount for the high-pressure part in the first control mode produces minimum hydraulic pressure, when a vehicle stops, the oil amount for the high-pressure part in the second control mode produces hydraulic pressure allowing for torque transmission, when the vehicle is running, and the oil amount for the high-pressure part in the third control mode is set to ensure hydraulic response of the transmission.

10. The system of claim 1, wherein the electric oil pump keeps operating from when an engine of a vehicle is started to when the engine is stopped.

11. A drive control method for an electric oil pump, comprising:
setting an operation mode of the electric oil pump on the basis of data detected by a data detector;
determining a basic oil amount on the basis of oil amounts for a high-pressure part and a low-pressure part according to the set operation mode;
determining a final oil amount by compensating the basic oil amount;
determining a speed instruction of the electric oil pump on the basis of the final oil amount; and
controlling operation of the electric oil pump in accordance with the determined speed instruction.

12. The method of claim 11, wherein the oil amount for the high-pressure part and the oil amount for the low-pressure part supply operating hydraulic pressure to a transmission by separate pumps.

13. The method of claim 12, wherein the electric oil pump supplies operating hydraulic pressure to the transmission in accordance with a speed instruction and the speed instruction is determined on the basis of desired hydraulic pressure, oil temperature, and the final oil amount.

14. The method of claim 12, wherein the operation mode includes a first control mode set for a stopping condition and a second control mode set for a running condition.

15. The method of claim 14, wherein the operation mode further includes a third control mode set for a starting-condition, and
the third control mode is maintained for a predetermined time.

16. The method of claim 14, wherein the determining of the basic oil amount on the basis of the oil amounts for the high-pressure part and the low-pressure part in the set operation mode determines the oil amount for the high-pressure part and the oil amount for the low-pressure part from a basic oil amount map about a relationship between oil temperature and desired hydraulic pressure stored in a set operation mode.

17. The method of claim 14, wherein the controller compares the oil amount for the high-pressure part and the oil amount for the low-pressure part with each other and then sets a larger one as the basic oil amount, and determines the final oil amount by adding a compensation oil amount for leakage to the basic oil amount.

18. The method of claim 14, wherein the oil amount for the low-pressure part is determined for each operation mode on the basis of oil amount for cooling and lubricating the transmission.

19. The method of claim 15, wherein the oil amount for the high-pressure part in the first control mode produces minimum hydraulic pressure, when a vehicle stops, the oil amount for the high-pressure part in the second control mode produces hydraulic pressure allowing for torque transmission, when the vehicle is running, and the oil amount for the high-pressure part in the third control mode is set to ensure hydraulic response of the transmission.
